(19) United States
(12) Patent Application Publication
(10) Pub. No.: US 2025/0091127 A1
(43) Pub. Date: Mar. 20, 2025

(54) ALUMINUM-CARBON METAL MATRIX COMPOSITES FOR FASTENERS

(71) Applicant: Yazaki Corporation, Tokyo (JP)

(72) Inventors: Kyle Deane, Camarillo, CA (US); Markus Boehm, Nuernberg (DE); Jeyakumar Manickaraj, Newbury Park (CA); Stefan Maat, Camarillo, CA (US); Douglas Meyers, Los Angeles, CA (US)

(21) Appl. No.: 18/972,734

(22) Filed: Dec. 6, 2024

Related U.S. Application Data
(63) Continuation of application No. PCT/US2023/068013, filed on Jun. 6, 2023.
(60) Provisional application No. 63/365,997, filed on Jun. 7, 2022.

(51) Int. Cl. B22F 1/12; F16B 23/00; F16B 35/06

(52) U.S. Cl. CPC B22F 1/12; F16B 23/0007; F16B 35/06; B22F 2302/403; B22F 2304/05; F16B 2200/93

(57) ABSTRACT

A fastener configured for an electrical power distribution application is disclosed. The fastener includes an aluminum (Al) metal matrix composite (MMC) comprising nanoscale carbon particles in a concentration of 0.01 to 2 percent by weight (wt %). The nanoscale carbon particles are evenly distributed throughout an entirety of the MMC. The fastener is useful for connecting conductors such as busbars, wires, or cables. Also disclosed is a method for fabricating the aluminum MMC fastener comprising a solid-state deformation process.

### CROSS-REFERENCE TO RELATED APPLICATIONS

This application claims priority to, and is a 35 U.S.C. § 111 (a) continuation of, PCT international application number PCT/US2023/068013 filed on Jun. 6, 2023, incorporated herein by reference in its entirety, which claims priority to, and the benefit of, U.S. provisional patent application Ser. No. 63/365,997 filed on Jun. 7, 2022, incorporated herein by reference in its entirety. Priority is claimed to each of the foregoing applications.

### TECHNICAL FIELD

The disclosed teachings relate to metal composites for fasteners.

### BACKGROUND

A fastener is a hardware device that mechanically joins or affixes two or more objects together. In general, fasteners are used to create non-permanent joints; that is, joints that can be removed or dismantled without damaging the joining components. Welding is an example of creating permanent joints. Steel fasteners are usually made of stainless steel, carbon steel, or alloy steel.

Other alternative methods of joining materials include crimping, welding, soldering, brazing, taping, gluing, cement, or the use of other adhesives. Force may also be used, such as with magnets, vacuum (e.g., suction cups), or even friction (e.g., sticky pads). Some types of woodworking joints make use of separate internal reinforcements, such as dowels or biscuits, which in a sense can be considered fasteners within the scope of the joint system, although on their own they are not general-purpose fasteners.

### BRIEF DESCRIPTION OF THE DRAWINGS

One or more embodiments of the present disclosure are illustrated by way of example and not limitation in the Figures of the accompanying drawings, in which like references indicate similar elements.

FIG. 1 shows an exemplary process flow chart for metal matrix composite (MMC) fastener production.

FIG. 2 illustrates a general drawing of one type of fastener.

FIG. 3 is a graph that shows beneficial physical properties of aluminum (Al) with 0.5 percent by weight (wt %) carbon nanotubes (CNT) in an as-extruded condition, and of Al with 0.75 wt % CNT in extruded and drawn condition, compared with the properties of pure aluminum.

FIG. 4 is a graph that shows creep testing results for an Al 0.75 wt % CNT sample, compared with results for pure Al (A199.7) and Al 6000-series alloy samples.

FIG. 5 is a graph that shows how cold working affects the strength of Al-0.5 wt % CNT MMC wire, compared with the strength of pure Al wire.

FIG. 6 is a graph that shows results of thermal stability testing on drawn Al-0.5 wt % CNT wires with two different levels of applied cold work (85 and 98% area reduction).

FIG. 7 are pictures that show improvement in carbon-nanotubes (CNT) distribution with solid-state reprocessing.

FIG. 8 includes images of unique grain electron backscatter diffraction (EBSD) images demonstrating the benefits of even CNT distribution in drawn Al 0.5 wt % CNT MMC wires.

FIG. 9 includes plots comparing the thermal stability of drawn Al-0.5 wt % CNT MMC wires with a poor CNT distribution and with a more homogeneous CNT distribution.

FIGS. 10A and 10B show a test setup for the simulation of an electrical busbar to busbar connection using Al-CNT MMC fasteners to connect the busbars.

FIG. 11 is a chart showing the comparison of the pretension loss in a busbar to busbar connection for aluminum busbars in combination with a stainless steel fastener, vs. a connection consisting of Al-CNT MMC busbars with an Al-CNT MMC fastener.

Various features of the embodiments described herein will become more apparent to those skilled in the art from a study of the Detailed Description in conjunction with the drawings. Embodiments are illustrated by way of example and not limitation in the drawings, in which like references may indicate similar elements. While the drawings depict various embodiments for the purpose of illustration, those skilled in the art will recognize that alternative embodiments may be employed without departing from the principles of the disclosed technology. Accordingly, while specific embodiments are shown in the drawings, the technology is amenable to various modifications.

### DETAILED DESCRIPTION

The disclosed technology relates to techniques for producing aluminum (Al)-based metal matrix composite (MMC) fasteners with desirable strength, thermal stability, and creep resistance, without significantly reducing the electrical conductivity below that of pure Al. It is beneficial to create a fine dispersion of strengthening particles surrounded by an α-Al matrix that is relatively devoid of solute atoms. To achieve this, metal matrix composite (MMC) additions that have no significant solubility in α-Al are used. As carbon has no reported solid solubility in Al and exists in several nanoparticulate forms (e.g., nanoscale structures such as carbon nanotubes (CNT), which can be single-walled carbon nanotubes (SWCNTs) or multi-walled carbon nanotubes (MWCNTs), graphene nanoplatelets (GNPs), fullerenes, nanodiamonds), it is an ideal candidate as an addition for Al-based MMC fasteners for electrical power distribution applications.

In an embodiment, the strengthening particles comprise carbon in the form of carbon nanotubes (CNT). The CNT may be single-wall CNT, multi-wall CNT, or a combination of the two types.

In another embodiment, the strengthening particles comprise carbon in the form of graphene nanoplatelets (GNP), fullerenes, nanodiamonds, or any combination thereof.

In another embodiment, the strengthening particles comprise carbon in predominantly sp² or sp³ hybridized form. Examples of predominantly sp² hybridized carbon include CNT, GNP, and fullerenes. An example of a predominantly sp³ hybridized carbon is nanodiamond. Amorphous carbon and carbon black are examples of carbon forms that are mixtures of sp² and sp³ hybridized forms.

A small addition of carbon (C) nanoscale particles to Al provides for an increased tensile strength of Al while maintaining a substantially similar conductivity, modulus of elasticity, and coefficient of thermal expansion compared to Al. For example, a composite product of Al and carbon nanotubes (CNT), or “Al-CNT” composite product, gains its tensile strength through work and dispersion hardening. During cold working by rolling, drawing, or other process, the grain structure is refined and CNT disperses more evenly in the matrix. While the tensile strength of Al-CNT increases with CNT content, the electrical conductivity slightly decreases. From that perspective, a concentration of 0.1-1.0 wt % CNT is preferred, which maintains an electrical conductivity of ˜60% International Annealed Copper Standard (IACS).

Aluminum 0.5 wt % CNT extruded products have been shown to exhibit higher strength and heat resistance compared to standard Al conductors while exhibiting a conductivity similar to 1000-series Aluminum (60.8% IACS). Strength in excess of 200 MPa and even in excess of 300 MPa, and thermal stability meeting AT4-level requirements of IEC 62004, “Thermal-resistant aluminium alloy wire for overhead line conductor,” have been measured. Mechanical strengthening of Al-CNT composite by work and dispersion hardening is achieved by successively reducing the cross-section of an extruded Al-CNT rod by cold working (e.g., rolling, drawing) to a desired diameter. This disclosure includes the applicability of work and dispersion hardened Al-CNT rods for the manufacturing of Al fasteners, suitable for electrical and/or high temperature applications.

To achieve the greatest benefit from nanoscale carbon additions, an even distribution of the particles throughout the MMC should be attained. Depending on the desired scale of production and the form of carbon used, an even distribution can be accomplished in several ways. For example, adding C particles to an Al melt and casting the MMC is one approach, but one in which challenges exist such as surface tension effects, the density differences of C and liquid Al, and the potential for burning the C addition at Al melting temperatures. A second method is to use powder metallurgy techniques to evenly mix and sinter Al and nanoscale C powders together into a solid billet. Finally, a third method involves mechanically mixing nanoscale C additions into an Al substrate through solid state processing techniques such as friction stir processing, equal channel angular pressing (ECAP), extrusion, etc.

The desired resulting MMC product has a carbon particle (e.g., CNT) concentration that is evenly distributed over its entire volume. That is, there are no significant irregular voids or irregular empty spaces between carbon particles, the carbon particles are not aggregated (or any aggregations are negligible), and there are no areas of higher or lower concentrations of carbon particles throughout the entire product volume. The amount of carbon particles in a matrix is essentially the same in all portions of the matrix volume, i.e., there are no portions within the composite that have a distinct difference, for example, more than 20%, more than 10%, or preferably more than a 5% difference, in carbon particle concentration from any other portion.

In one example, the resulting MMC product has a uniform density that is non-porous. For example, the density may deviate by 2% at most from a theoretical composite density, which can be calculated based on the volume of the material, the relative amounts of Al and carbon particles, and their respective densities. The even carbon particle concentration of a sample Al-C MMC provides consistent and uniform characteristics such as uniform conductance throughout the entire volume of the MMC product. The uniform distribution of carbon particles in a sample Al-C MMC product can be verified by high resolution microscopy.

Regardless of the technique used to produce the Al-C MMCs, the final amount of residual stress from processing will have an impact on the resulting strength and elongation of the MMC. For fastener applications that require significant elongation or thermal stability, care should be taken to achieve a final condition that is relatively free of residual stresses. One method to achieve a final condition suitable for this application is through annealing of the fasteners to relieve residual stresses after any necessary cold working procedures were performed. Another method is to initially produce the MMC with near-final dimensions and geometry, using a process that runs at elevated temperatures (e.g., extrusion) to limit the occurrence of residual stresses. If a higher strength is desired and elongation and thermal stability are of lesser importance, introduction of residual stresses, for example through the application of cold work, is a viable method of increasing the strength.

### Fasteners for Busbar Applications

Al-C MMC (e.g., Al-CNT MMC) has improved properties compared to common Al-alloys. Examples of the improved properties include higher strength, higher electrical conductivity, higher thermal resistance, and greater creep resistance. As fasteners, Al-C MMC materials provide reliable and efficient connectors for electrical applications, e.g., the connection of busbars, battery components or utility wires.

As used herein, the term “aluminum-based” can refer to pure Al, Al alloy, or Al-based MMC. Examples of applications for aluminum-based fasteners are found in the transportation, telecommunications, utility, and power generation industries. For example, efficiently mounting and connecting electrical components to Al busbars in vehicles is of growing importance. The disclosed embodiments provide a viable solution for fastening aluminum-based busbars to other components in a convenient, consistent, and safe manner. In electric vehicle/hybrid electric vehicle (EV/HEV) battery module assembly connections, the connectors should have high strength, conductivity (thermal and electrical) and thermal stability. Standard current carrying capacity for aluminum is about 0.7 A/mm², which is sufficient for use in connecting the battery module in EVs/HEVs. The electrical power requirements in EVs/HEVs continue to increase such that the need for efficient connections is also increasing.

Electrical conductivity of a conductor grade Al alloy such as AA 1350 is 61.2 to 61.8% IACS, and its strength is low as compared with copper (Cu). The addition of alloying elements to Al increases the strength (e.g., 2xxx, 5xxx, 6xxx, and 7xxx series alloys), but typically reduces the conductivity. Further, the thermal stability of Al alloys is low, as the strengthening additions used in commercially available alloys have relatively high mobility in the Al matrix. Because of this, Al alloys are typically not used for applications that see temperatures above 150° C. However, carbon-reinforced aluminum (Al-C) MMCs, for example aluminum-carbon nanotube (Al-CNT) MMCs, can provide high strength and thermal stability without a significant loss of electrical conductivity.

Al-CNT MMCs have high specific strength and excellent thermal and electrical properties. The quantity and distribution of CNT in the Al matrix are key parameters to achieve the maximum strength of the Al-CNT composite. The length of CNTs in Al-CNT MMCs may not affect the strength of the composites; however, the mechanism used to strengthen the composites can change with the length of CNTs. Uniform CNT distribution is important for determining certain properties, as the tendency of CNTs to form agglomerates has resulted in some studies in which lower strength was observed for higher CNT content, due to CNT agglomeration. For instance, one study observed that 0.1 wt % CNT yielded a high strength compared with 0.25, 0.5, and 1.0 wt % CNT due to the uniform dispersion of CNTs without agglomeration in the 0.1 wt % CNT MMC as compared to MMCs with higher CNT contents (>0.25 wt % CNT). Another study showed that 0.5 wt % CNT resulted in improved mechanical properties as compared with 1.0 wt % CNT in Al-CNT composites due to the extensive agglomeration formation in the higher-content CNT composites. Hence, higher CNT concentrations could be deemed beneficial as long as the CNTs are distributed evenly without significant agglomeration.

Replacing Cu busbars with Al provides significant weight and cost reduction. However, the transition from Cu to Al busbars requires making additional changes to compensate for differences in properties between Al and Cu. For instance, Cu busbars are frequently connected to components by steel fasteners, whereas differences in thermal expansion coefficients, creep behavior, and galvanic potential make connecting Al busbars with steel fasteners dangerous. Further, safe electrical distribution with Al conductors requires care to avoid dangerous conditions that could result in hotspots and eventual failed connections. The two leading causes of these failures are (i) galvanic corrosion and (ii) connection loosening due to differences in thermal expansion coefficients and creep. Galvanic corrosion occurs between dissimilar metals in the presence of an electrolyte. Al is a strong anode and will corrode aggressively when galvanically coupled with Cu or stainless steel. Therefore, connecting a Cu busbar to an Al busbar with a stainless-steel fastener can be problematic unless proper precautions are taken (using Ni coatings, shielding the junction from environmental moisture, etc.). These precautions can be cost-prohibitive and cause failures if misapplied. Loosening connections due to differences in thermal expansion coefficients and creep behavior can cause failures in Al electrical distribution systems. In particular, because the Al conductor expands and contracts faster with temperature changes compared to the material clamping it (e.g., a stainless-steel fastener), a compressive force is applied to the Al conductor whenever heated. Normal usage generally causes temperature cycling, either through heat generated by resistance in the conductor (Joule heating), changes in ambient conditions, or from components surrounding the conductor, and this cyclic loading/unloading can cause the conductor to deform at the connection. With this deformation, less force is applied at elevated temperatures, but there may be no or limited electrical contact at lower temperatures.

The disclosed technology addresses problems associated with joining Al with dissimilar metals. The potential for failure is reduced if the number of dissimilar junctions is reduced. Hence, all-Al junctions are an attractive option. For example, connecting two Al busbars with an Al bolt and Al nut avoids the aforementioned failures. Al alloy fasteners are commercially available but the disclosed Al-C MMCs (e.g., Al-CNT MMCs) provide distinct advantages over existing alloys for fastener applications. In particular, the disclosed MMC fasteners have improved properties including higher thermal stability, tensile strength, and electrical conductivity, compared to current Al alloys that are used in fastener applications.

Prior Al fasteners are mainly produced from 6000-series alloys (e.g., EN AW 6056). These fasteners reach an ultimate tensile strength (UTS) of up to about 500 MPa, a yield strength of up to 400 MPa, and an elongation of about 7%. The maximum applicable temperature for these fasteners is about 150° C. or 180° C. for short duration.

The disclosed embodiments include Al-MMC fasteners having various combinations of properties in as-extruded, cold-worked, or cold-worked and annealed condition. The combinations of properties include electrical conductivity, UTS, and elongation that are less than, equal to, or greater than certain values.

In an embodiment, an Al-C MMC fastener has an electrical conductivity greater than about 50% IACS, an UTS greater than about 80 MPa, and an elongation greater than about 30%. The fastener with such properties can be in as-extruded or mildly cold-worked condition, or cold-worked and annealed.

In another embodiment, an Al-C MMC fastener has an electrical conductivity greater than about 50% IACS, a UTS greater than about 120 MPa, and an elongation greater than about 10%. The fastener with such properties can be in as-extruded, cold-worked, or cold-worked and annealed condition.

In another embodiment, an Al-C MMC fastener has an electrical conductivity greater than about 50% IACS, a UTS greater than about 200 MPa, and an elongation greater than about 3%. The fastener with such properties is typically in cold-worked, or cold-worked and annealed condition.

In another embodiment, an Al-C MMC fastener has an electrical conductivity greater than about 50% IACS, a UTS greater than about 300 MPa, and an elongation greater than about 1%. The fastener with such properties is typically in cold-worked, or cold-worked and annealed condition.

In a preferred embodiment, an Al-C MMC fastener has an electrical conductivity greater than about 55% or greater than about 58% IACS, a UTS greater than about 180 MPa, and an elongation greater than about 10%, in either cold-worked or cold-worked and annealed condition.

In an embodiment, an Al-C MMC fastener has superior creep resistance compared with fasteners produced from commercial aluminum alloys such as 6000-series alloys. The Al-C MMC fastener typically shows a total displacement of less than about 5%, or less than about 1% after being tested for 100 hours at 150° C., with an applied tensile stress equivalent to 80% of the fastener's room-temperature yield strength. The Al-C MMC fastener typically shows a total creep of less than about 5%, or less than about 3%, after being tested for 500 hours at 150° C., with an applied tensile stress equivalent to 80% of the fastener's room-temperature yield strength.

The Al-CNT MMC fasteners provide improved thermal stability, allowing use at temperatures greater than 200° C. The improved thermal stability provides high creep resistance compared to commercially available Al alloys. The thermal stability is required for fasteners to maintain the necessary pretension on the connected parts and is critical for connections in electrical applications because contact resistance is directly influenced by pretension. For electrical applications, the high specific electrical conductivity of Al-CNT is about 60% IACS, compared to about 52% IACS for the 6000-series alloys, providing an additional advantage.

### Production Details

The disclosed embodiments include techniques for producing Al-C MMC fasteners that contain small amounts of nanostructured C additions such as CNTs, GNPs, fullerenes, and/or nanodiamonds. In some examples, the amount of nanostructured C additions is between 0.01 and 2.0 percent by weight (wt %), between 0.1 and 1.0 wt %, or between 0.2 and 0.8 wt %. In some embodiments, the amount of C addition is about 0.4 wt %, about 0.5 wt %, about 0.6 wt %, about 0.7 wt %, or about 0.8 wt %. Production of Al-C MMC fasteners can be accomplished in accordance with different processes including those described in the following examples.

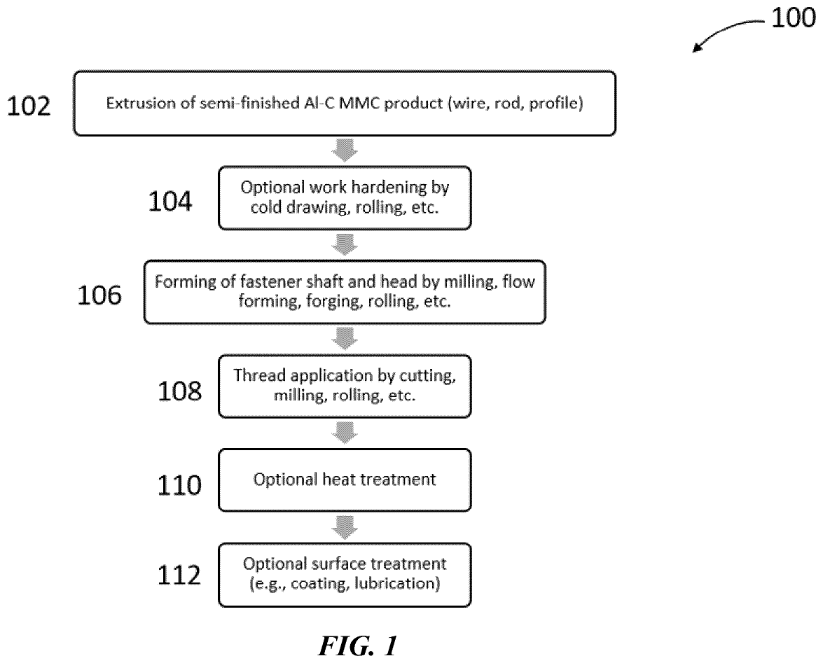

An exemplary process 100 for MMC fastener production is illustrated in FIG. 1. At 102, a semi-finished MMC product such as a wire, rod, or other profile is fabricated by extrusion. At 104, the semi-finished MMC product is optionally work-hardened by cold drawing, rolling, or the like. At 106, the fastener shaft and head are formed by one or more of various techniques such as milling, flow forming, forging, rolling, or the like. At 108, the threads on the fastener are formed by cutting, milling, rolling, or other appropriate method. This completes the geometric formation of the fastener. Optional heat treatment and optional surface treatment are then applied at 110 and 112, respectively.

The extrusion step 102 can be used to accomplish several objectives in the production of Al-C MMC fasteners. One objective is to produce specific shapes and dimensions of the extruded product. These dimensions may coincide with the targeted final dimensions required for fastener production in the case that more value is placed on the elongation than the strength of the fastener, or the extruded dimensions may be oversized in the case that cold working (e.g., drawing or rolling) will be employed to increase the strength while decreasing the cross-sectional area to the targeted dimensions. In addition to geometric objectives such as size and shape, extrusion with the proper tooling and parameters can be used to increase homogeneity of C additions in poorly homogenized Al-C feedstock that was produced by other means.

Using extrusion to increase the homogeneity of Al-C MMCs can result in a significant performance improvement in terms of strength, thermal stability, etc. Depending on the extrusion process used, an Al-MMC feedstock material can be in the form of Al-C rods, bars, granules, compacted powder billets, etc., and multiple passes through the extrusion process can be employed to further improve homogeneity if needed.

The optional work hardening step 104, involving cold drawing, rolling, or the like, can be performed on Al-C MMCs to achieve the target size and dimension required for fastener production. This process can be performed at room temperature, and can be performed at elevated temperatures to relieve internal stresses if high elongation in the final fastener product is desired, as the residual stresses from cold working will generally reduce elongation and increase strength. As an alternative to hot rolling, a heat treatment can also be applied after cold rolling as a method to relieve residual stresses after production.

The forming step 106 is performed on the semi-finished Al-C MMC product as part of fastener production. For example, the head and/or shaft of the fastener is created through milling, flow forming, forging, rolling, or other suitable technique. The ease of forming will depend on the structure and amount of C included in the MMC, as well as the grain size and amount of residual stress present in the material at the time of forming. For optimal forming capability of any specific Al-C MMC, care should be taken to reduce residual stresses at the time of forming, by either avoiding cold work by producing the material with close-to-final dimensions or by annealing at a temperature high enough to relieve stresses accumulated during cold working procedures. However, if the strengthening provided by the residual stresses is necessary for the properties of the final fastener application, some forming can still be performed with little or no annealing.

The fastener threads are formed in step 108 via a machining or forming technique. Examples of machining techniques include cutting, milling, or the like. Examples of forming techniques include rolling, forging, or the like. Forming processes are generally more preferable if possible. Machining steps may be employed in the case of small batch manufacturing, or if the fastener geometry requires sharp edges or other features that are difficult or impossible for forming processes.

An optional heat treatment step 108 may be employed to impart desired mechanical, thermal, and/or electrical properties to the finished fastener product. For example, an annealing heat treatment may be used to increase the thermal stability of the product. Such heat treatment may impart other desired properties such as higher elongation, higher electrical conductivity, etc. The heat treatment may be employed as well to reduce residual stresses accumulated in the product during the various forming and/or machining steps in the fabrication process.

An optional surface treatment step 110 may be employed to impart desired surface properties to the finished fastener product. For example, a plating or coating may be applied for corrosion resistance, improved wear properties, or for lubrication.

### Fastener Geometries

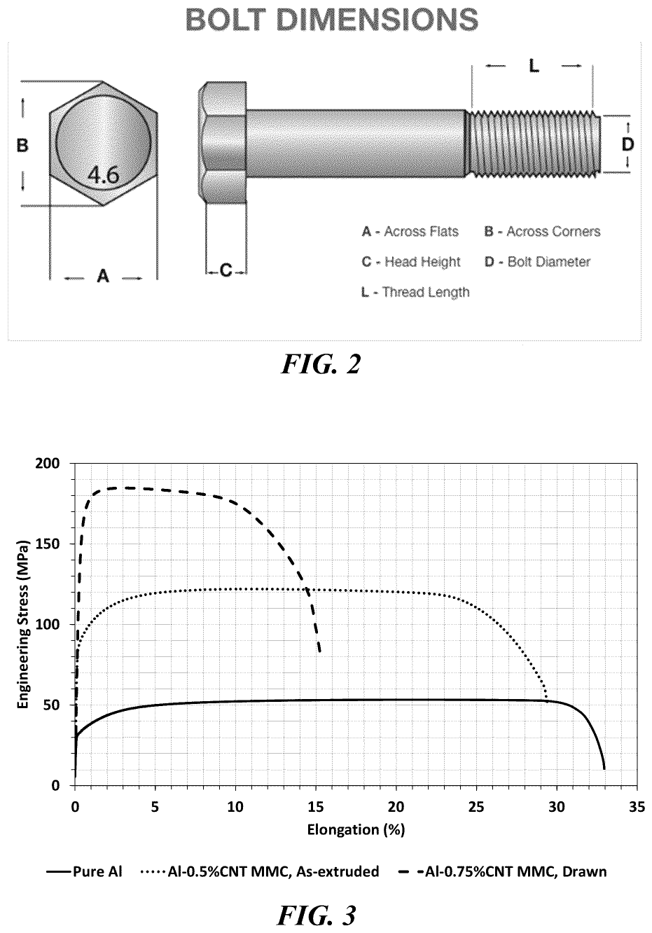

A general drawing of an example fastener is shown in FIG. 2, but various geometries of fasteners are within the scope of the disclosed embodiments. Depending on the application, the diameter of the fastener's shaft can be between 2 mm and 16 mm, for example. The fasteners can follow metric standards, imperial standards, or any other specification. The length of the fastener shaft can vary, for example, from 5 to 50 mm to allow for fastening a wide range of components with varying thicknesses. The threads can cover the entirety of the shaft, or only a portion of the shaft.

The head of the fastener can vary to accommodate geometric requirements, to allow for greater or lesser ease of disassembly, or to adjust the contact area of the fastener to the top of the component that is being fastened. Variations in head design can include changing the overall style. Some possible head styles include: binding, fillister, countersunk, flat, hexagon, oval, pan, round, square, truss, and torque along with any variations of those styles. Fastener heads can be designed to interface and be tightened with a variety of tools, including torque wrenches, standard wrenches, Allen keys, screwdrivers of various types and shapes (e.g., Phillips), and specialty toolsets designed to discourage unauthorized disassembly.

### Examples of Al-C MMC Properties without Significant Residual Stress

### A. Strength and Elongation Behavior of As-Extruded Al-CNT MMC

FIG. 3 is a graph that shows beneficial physical properties of Al-0.5 wt % CNT (Al-CNT MMC) in an as-extruded condition, and of Al-0.75 wt % CNT in extruded and drawn condition, compared with properties of pure Al in as-extruded condition. More specifically, FIG. 3 includes a tensile test that shows the properties of an as-extruded Al-0.5% CNT rod 8.3 mm in diameter, with UTS of about 120 MPa and elongation of about 24%. FIG. 3 also shows the properties of an extruded and cold-drawn Al-0.75% CNT rod 8.3 mm in diameter, with UTS of about 185 MPa and elongation of about 10%. The as-extruded pure Al busbar, in contrast, shows UTS of about 52 MPa and elongation of about 29%. The UTS of the as-extruded MMC busbar of about 120 MPa is higher than that of many common Al conductors in soft condition (e.g., Al-1350-O with UTS of about 60 MPa). The UTS of the extruded and cold-drawn MMC busbar of about 185 MPa is similar or higher than that of many 6000-series Al alloys used for electrical applications.

### B. Conductivity of As-Extruded Al-CNT MMC

The conductivity of as-extruded Al-0.5 wt % CNT MMC, measured on wire samples produced in several different production runs, was consistently in the range of 59.5-60.5% IACS.

### C. Creep Behavior of As-Extruded Al-CNT MMC

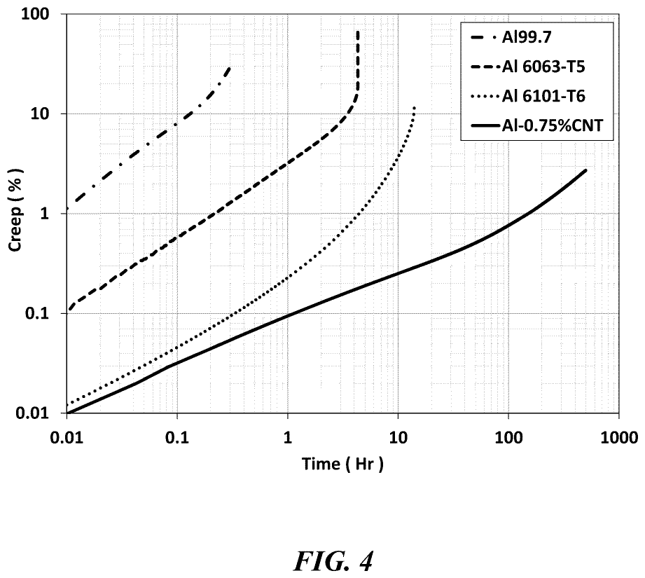

FIG. 4 shows the results of creep testing performed on an Al-0.75 wt % CNT sample, and for comparison, on an Al6101-T6 alloy sample, an A6063-T5 Al alloy sample, and a pure Al (A199.7) sample. The tests were performed at 150° C. and with the samples loaded to 80% of their respective room temperature yield strengths. As shown, the Al-CNT MMC has improved creep properties. The tertiary creep stage was not reached in Al-0.75wt % CNT before the test was interrupted at 500 hours, whereas the 6063 alloy sample failed completely after about 4 hours, the 6101 sample failed after about 15 hours, and the pure Al sample failed after less than 1 hour.

### Examples of Al-C MMC Properties after Cold Working to Add Residual Stress

### A. Strength and Elongation Behavior of Cold-Worked Al-CNT MMC

The initial extrusion diameter, Di of an Al-CNT rod for a desired ultimate strength (UTS) and final diameter, Df of the wire can be calculated from the relationship:

$${D}_{i} = {D}_{f} * 10 * exp ( \frac{U T S - A}{2 B} )$$

where A and B are constants that depend on the amount of CNT. For an MMC with a nominal 0.5 wt % CNT content, A and B can be about 274 and 34, respectively.

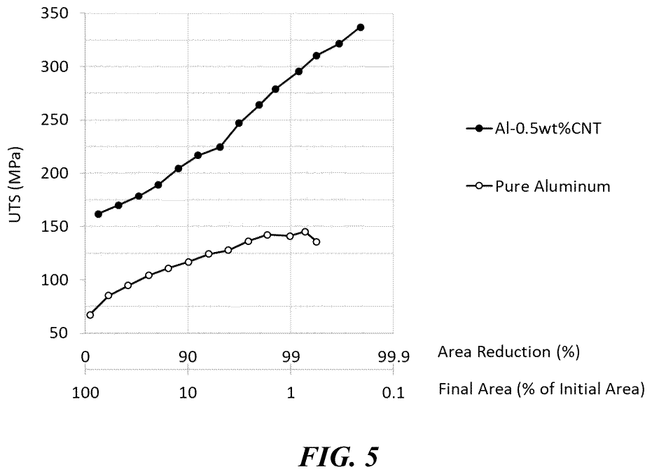

FIG. 5 is a graph that shows how cold working affects the strength of Al-0.5 wt % CNT MMC and Al round wires with reduction of cross-sectional area. More specifically, FIG. 5 shows plotted strength improvement with added cold work (wire drawing) for Al-0.5 wt % CNT and Al wires.

Based on the data, strengths as high as about 335 MPa were observed in the Al-0.5 wt % CNT MMC with a sufficient cold working area reduction. In contrast, pure Al wire initially increased in strength with cold work but at a somewhat reduced rate compared with the MMC. Moreover, the UTS of the pure Al wire reached a plateau at about 140 MPa. The elongation of the MMC stays consistent at 3-5% at all levels of cold working. This behavior does not change significantly when using this material for busbar applications rather than wire. As an alternative to area reduction, processes that apply internal stresses without changing the cross-sectional area (ECAP, etc.) could be used to increase strength in busbars that were initially produced at or near final target dimensions.

### B. Conductivity of Cold-Worked Al-CNT MMC

Conductivity of cold-worked Al-CNT wires is observed to be in a similar range as for the wires before cold working was applied, at 59-60.5% IACS.

### C. Thermal Stability of Cold-Worked Al-CNT MMC

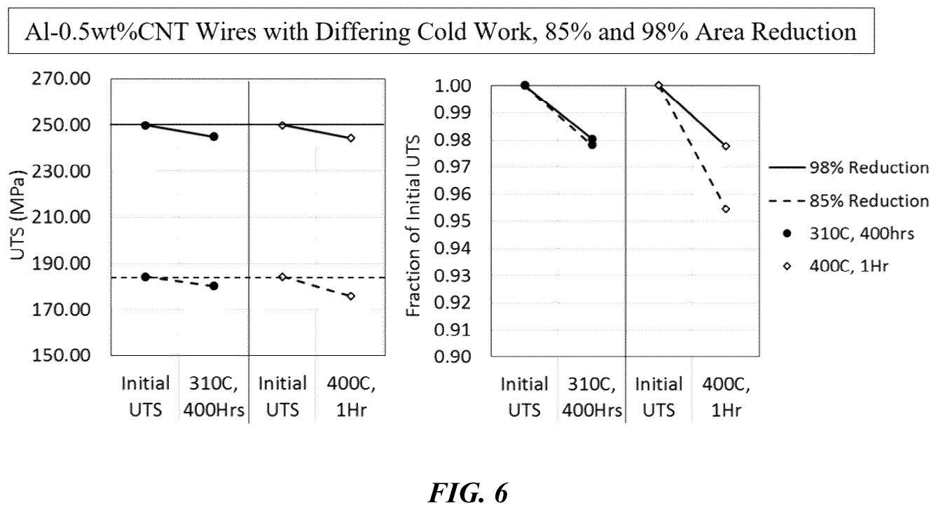

To assess the thermal stability of Al-CNT MMC products, heat treatments for AT4 classification (the highest classification of thermal stability described in IEC62004) were applied to drawn Al 0.5 wt % CNT wires with two different levels of applied cold work (85% and 98% reduction in cross-sectional area). Aluminum-based materials that meet the AT4classification are capable of continuous operation at 230° C. for 40 years. To qualify for AT4 thermal stability, the wires must maintain over 90% of their UTS after being held at 310° C. for 400 hours. They must also maintain over 90% of their UTS after being held at 400° C. for 1 hour. As shown in FIG. 6, both of the drawn Al-0.5 wt % CNT wires passed this test, demonstrating excellent thermal stability. This behavior extends to fastener applications provided similar levels of cold work are applied.

For certain applications, Al-CNT MMC fasteners meeting the less stringent AT3 standard for thermal stability described in IEC62004 may be sufficient while still providing substantially better performance compared to commercially available aluminum alloy fasteners. To qualify for AT3, wire samples must maintain over 90% of their UTS after being held at 280° C. for 1 hour, or after being held at 240° C. for 400 hours. As it has been shown that the Al-CNT MMC disclosed herein meets the more stringent AT4 standard, it is also apparent that the MMC products also meet the less stringent AT3 standard.

### Examples of Improving Homogeneity of Carbon Addition in Al-C MMCs

### A. Improving Homogeneity in Al-CNT MMC with Extrusion Processing

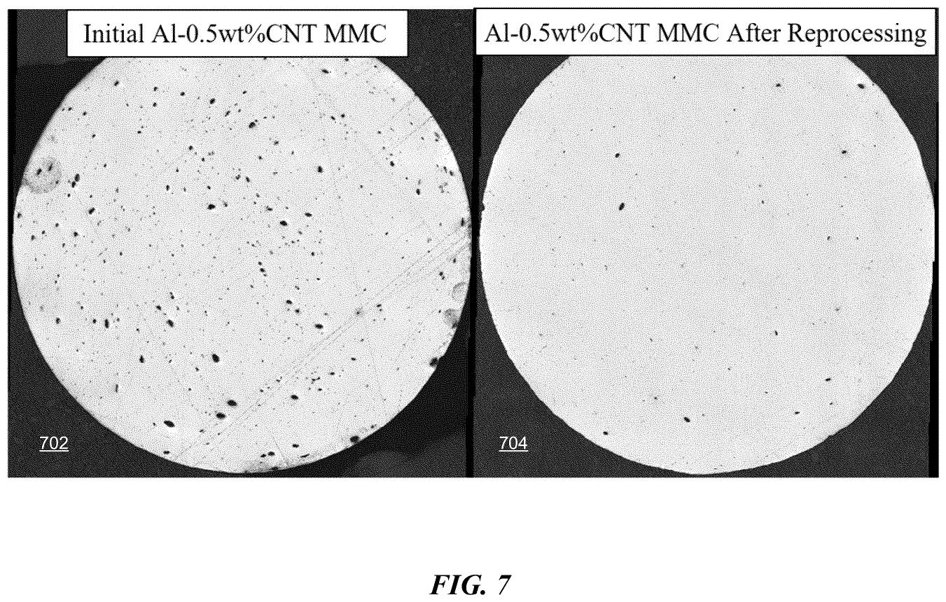

FIG. 7 includes images that show microstructural differences between two Al 0.5 wt % CNT MMCs, before and after homogeneity is increased by extrusion processing. The figure shows improvement in CNT distribution with solid-state reprocessing. In the initial MMC 702, agglomerated CNTs are visible as black spots in the image. After extrusion processing 704, the number and size of large visible black spots is reduced while the measured C content remains consistent. More specifically, the images of FIG. 7 are cross-sectional micrographs of an Al-0.5 wt % CNT MMC wire with high levels of undesirable CNT agglomeration before (702) and after (704) an added extrusion process to increase CNT homogeneity. The visible black spots are CNT agglomerates, and the notable decrease in the size and number density of these spots with the extrusion processing indicates that the process broke up the agglomerates and more evenly distributed the CNT. Carbon concentration measurements verify that the C content of these MMCs remained unchanged by this processing. As such, the same quantity of CNT is expected to be present in both. From this and other observations, it is apparent that the large CNT agglomerates are broken up and the CNT is distributed more evenly by the extrusion process. This has several benefits for the properties of the MMC, as discussed below.

### B. Thermal Stability Improvement in Al-CNT MMC

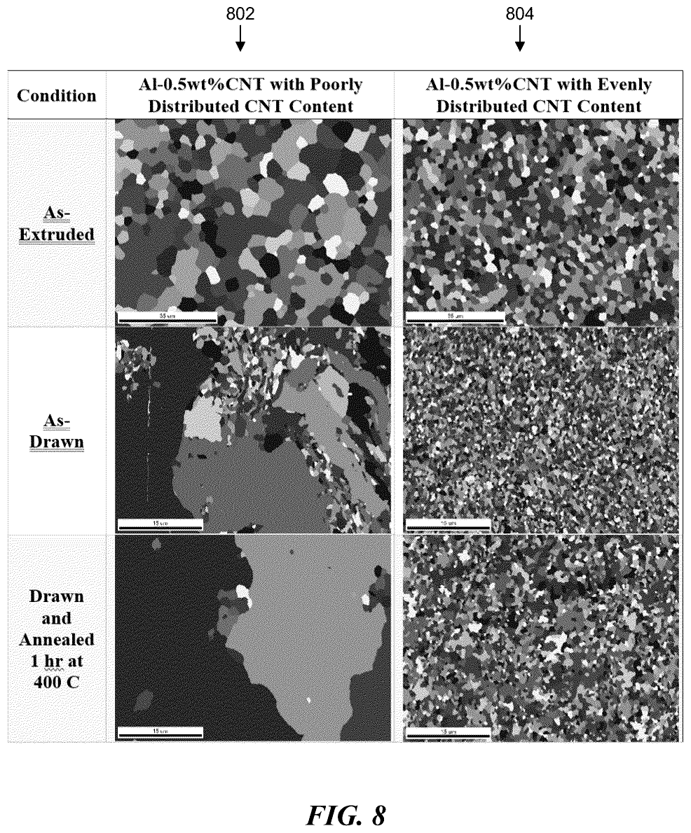

Improving the homogeneity of CNT distribution within Al-CNT MMCs also increases thermal stability. For example, FIG. 8 shows how heat treatment (i.e. annealing) of a drawn Al-0.5 wt % CNT MMC wire containing visible CNT agglomerates affects grain size compared to a second drawn Al-0.5 wt % CNT MMC wire with a more homogeneous CNT distribution. In the sample with poorly dispersed CNT, grain growth occurs unchecked in some regions of the sample, while other regions resist grain growth. This is due to pockets in the MMC with relatively low or nonexistent quantities of CNT which have similar thermal stability as pure Al. This phenomenon is not observed in samples with more evenly distributed CNT content (e.g., smaller/fewer CNT agglomerates with the same C content).

More specifically, FIG. 8 shows electron backscatter diffraction (EBSD) images of Al-CNT MMC grains, which demonstrate benefits of homogeneous CNT distribution in drawn Al 0.5 wt % CNT MMC wires as opposed to a less homogeneous CNT distribution. The poorly dispersed sample (802) has a larger initial grain size and exhibits a non-homogeneous CNT distribution and excessive grain growth with drawing and annealing. The sample with a more homogeneous CNT distribution (804) exhibits a smaller initial grain size and maintains a relatively consistent and homogeneous grain size throughout the sample when subjected to the same cold working and heat treatment. As a consequence of the poorly dispersed CNT in the Al-0.5 wt % CNT sample, grains are free to grow within certain internal regions without obstruction and hence the properties of this sample are significantly less thermally stable than in Al-0.5 wt % CNT samples with more evenly dispersed CNT.

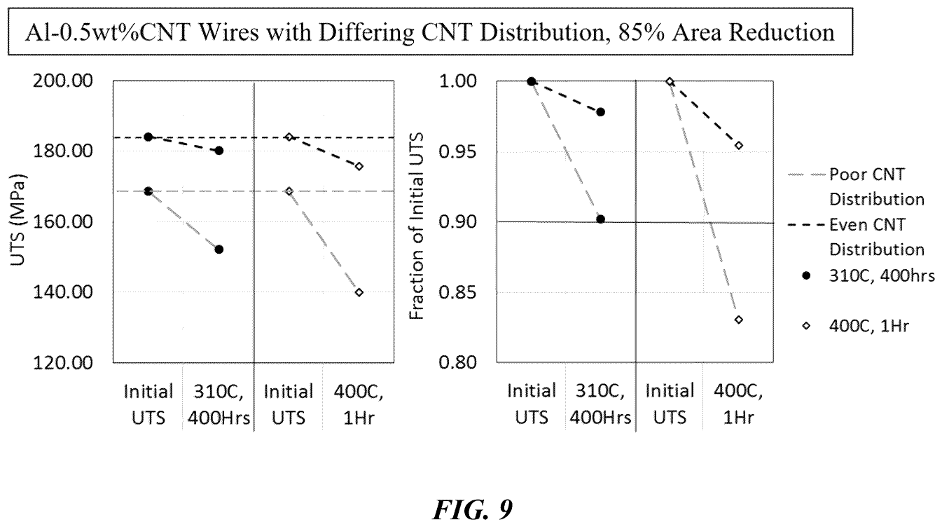

FIG. 9 shows that the Al-CNT MMC with poor CNT distribution fails the AT4 test per IEC 62004, whereas samples with more homogeneous CNT distribution succeed (see, e.g., FIG. 6 and related text). More specifically, FIG. 9 shows plots comparing the thermal stability of drawn Al-0.5 wt % CNT MMC wires with poor CNT distribution versus those with more homogeneous CNT distribution. As in FIG. 6, samples need to maintain >90% of their initial UTS to qualify for AT4 thermal stability. The poorly distributed CNT sample does not pass AT4 thermal stability. This comparison emphasizes the importance of breaking up CNT agglomerates in Al-CNT MMCs to achieve their full potential.

### Example of Al-CNT MMC Fastener Properties Compared to Steel Fasteners

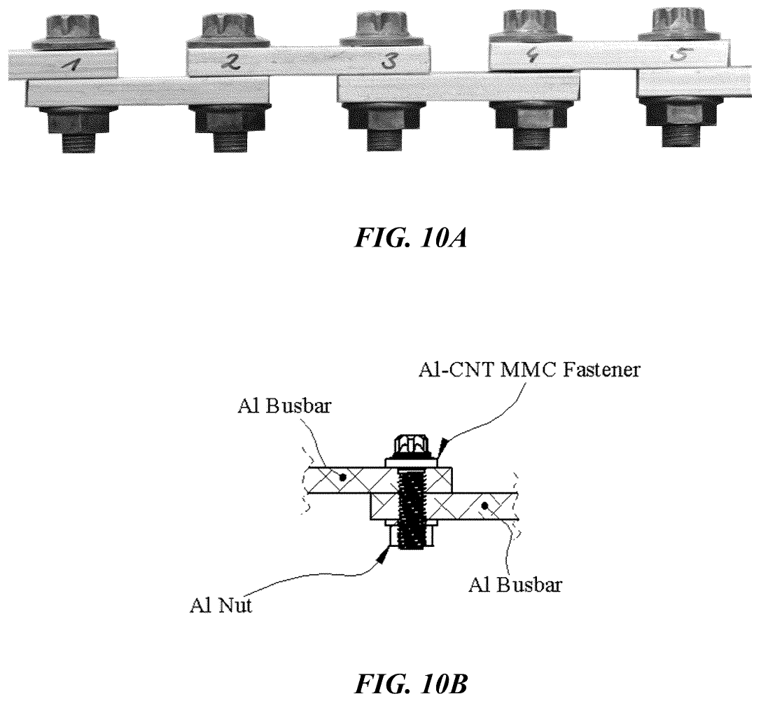

FIGS. 10A and 10B show a setup for the simulation of an electrical transmission assembly for a busbar-to-busbar connection. Such connections are found in high powered electrical applications, e.g., in battery connectors for automotive applications. In such applications, aluminum components are beneficial over currently used copper components, due to the significant potential in cost and weight reduction. The demand for a wide performance range regarding the ampacity of these conductors and connectors requires a high thermal stability of the connection system due to the occurring resistive heating at high electrical load. The use of common steel fasteners for these connections generates unstable connection conditions at elevated temperatures, due to the differences of thermal expansion between the aluminum busbar and the steel fastener. Moreover, steel has much lower electrical conductivity than copper, about 3-15% IACS. Thus, connections made by steel fasteners can cause hot-spots due to loose connections and low conductivity.

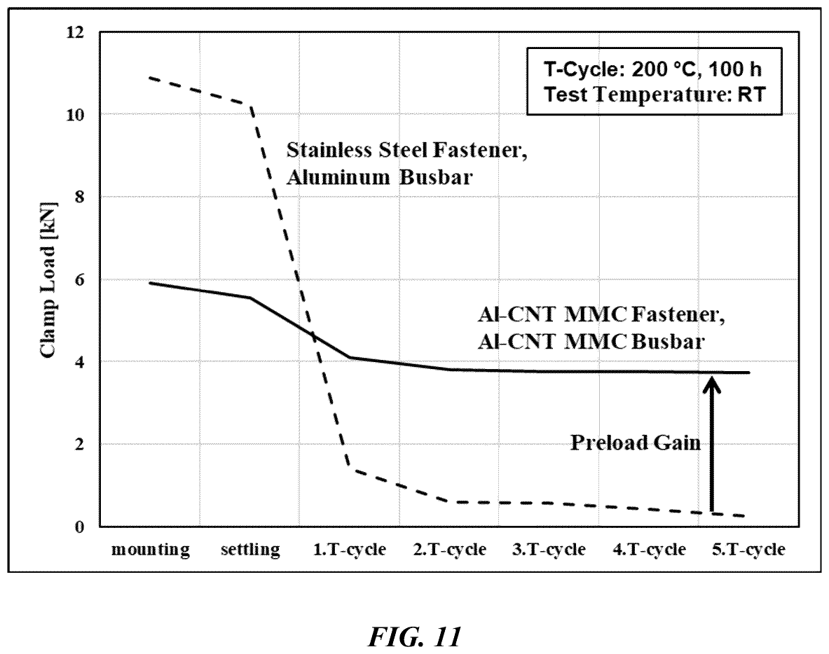

FIG. 11 is a chart showing a comparison of pretension loss in a busbar-to-busbar connection for aluminum busbars in combination with a stainless-steel fastener, versus a connection of Al-CNT MMC busbars in combination with an Al-CNT MMC fastener. The connecting systems were mounted at 20° C. with a setting time of one hour. After setting, the samples were exposed to a thermal cycle from 20° C. to 200° C. and back to 20° C. The dwell time at 200° C. was 100 hours for each cycle, and five cycles were conducted. After each cycle the remaining connecting pretension was determined.

Due to the high thermal stability (e.g., AT3 or even AT4 level) and the equal thermal expansion in the all-aluminum (MMC) connection, the measured pretension loss is in a range of 30% of the initial mounting pretension. In the case of aluminum busbars connected by a steel fastener, the pretension decreases by almost 90% after the first thermal cycle. This significant drop negates the high initial pretension that can be applied to the stronger steel fastener. Further high temperature exposure leads to a continuing loss in pretension, up to undefined low pretension. This direct comparison thus shows the potential for reliable electrical connections by utilizing Al-CNT MMC fasteners with aluminum-based conductors such as busbars.

### Remarks

The above description and drawings are illustrative and are not to be construed as limiting. Numerous specific details are described to provide a thorough understanding of the disclosure. However, in certain instances, well-known details are not described in order to avoid obscuring the description. Further, various modifications may be made without deviating from the scope of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not all necessarily referring to the same embodiment, nor are separate or alternative embodiments mutually exclusive of other embodiments. Moreover, various features are described, which may be exhibited by some embodiments and not by others. Similarly, various requirements are described, which may be requirements for some embodiments but not for other embodiments.

The terms used in this description generally have ordinary meanings in the art, within the context of the disclosure, and in the specific context where each term is used. Certain terms that are used to describe the disclosure are discussed above, or elsewhere in the description, to provide additional guidance to the practitioner regarding the description of the disclosure. It will be appreciated that the same thing can be said in more than one way. For example, one will recognize that a “screw” is one form of a “fastener” and that the terms may, on occasion, be used interchangeably.

Alternative language and synonyms can be used for any one or more of the terms discussed herein, and no special significance is to be placed upon whether or not a term is elaborated or discussed herein. Synonyms for certain terms are provided. A recital of one or more synonyms does not exclude the use of other synonyms. The use of examples anywhere in this description, including examples of any term discussed herein, are illustrative only and are not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given above. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

From the foregoing, it will be appreciated that specific embodiments of the invention have been described herein for purposes of illustration, but that various modifications may be made without deviating from the scope of the invention. Accordingly, the invention is not limited except as by the appended claims.

I/we claim:

1. A fastener configured for an electrical power distribution application, the fastener comprising:
an aluminum (Al) metal matrix composite (MMC) comprising nanoscale carbon particles in a concentration of 0.01 to 2 percent by weight (wt %),
wherein the nanoscale carbon particles are evenly distributed throughout an entirety of the Al-MMC.

2. The fastener of claim 1, wherein the concentration of the nanoscale carbon particles is in a range of 0.1 to 1 wt %.

3. The fastener of claim 1, wherein the concentration of the nanoscale carbon particles is in a range of 0.2 to 0.8 wt %.

4. The fastener of claim 1, wherein the nanoscale carbon particles comprise single-walled carbon nanotubes (CNTs).

5. The fastener of claim 1, wherein the nanoscale carbon particles comprise multi-walled CNTs.

6. The fastener of claim 1, wherein the nanoscale carbon particles comprise graphene nanoplatelets (GNPs), fullerenes, nanodiamonds, or any combination thereof.

7. The fastener of claim 1, wherein the nanoscale carbon particles comprise nanoparticles with predominantly sp² or sp³ carbon.

8. The fastener of claim 1, wherein the nanoscale carbon particles are selected from the group consisting of:
CNTs,
GNPs,
fullerenes,
nanodiamonds,
nanoparticles with predominantly sp² or sp³ carbon, and
any combination thereof.

9. The fastener of claim 1, wherein the fastener has an electrical conductivity greater than 50% International Annealed Copper Standard (IACS), an ultimate tensile strength (UTS) greater than 80 MPa, and an elongation greater than 30%.

10. The fastener of claim 1, wherein the fastener has an electrical conductivity greater than 50% IACS, an ultimate tensile strength (UTS) greater than 120 MPa, and an elongation greater than 10%.

11. The fastener of claim 1, wherein the fastener has an electrical conductivity greater than 50% IACS, an ultimate tensile strength (UTS) greater than 200 MPa, and an elongation greater than 3%.

12. The fastener of claim 1, wherein the fastener has an electrical conductivity greater than 50% IACS, an ultimate tensile strength (UTS) greater than 300 MPa, and an elongation greater than 1%.

13. The fastener of claim 1, wherein after heating the fastener either at 400° C. for 1 hour or at 310° C. for 400 hours, an ultimate tensile strength (UTS) is at least 90% of its UTS prior to heating.

14. The fastener of claim 1, wherein after creep testing for 100 hours at 150° C. with an applied load of 80% of its room-temperature yield strength, the fastener shows a total displacement of less than 5%.

15. The fastener of claim 1, wherein after creep testing for 500 hours at 150° C. with an applied load of 80% of its room-temperature yield strength, the fastener shows a total displacement of less than 5%.

16. The fastener of claim 1, wherein the electrical power distribution application includes an automotive application.

17. The fastener of claim 1, wherein the fastener is a bolt with shaft diameter in a range of 2-16 mm.

18. The fastener of claim 1, wherein the fastener is a bolt with shaft diameter in a range of 6-8 mm.

19. The fastener of claim 1, wherein the fastener is a bolt with a shaft length in a range of 5-50 mm.

20. The fastener of claim 1, wherein the fastener is a bolt with a head style selected from or related to any of the following:
binding,
fillister,
countersunk,
flat,
hexagon,
oval,
pan,
round,
square,
truss, and
torque.

21. The fastener of claim 1, wherein the fastener includes a bolt that is designed to be tightened with any of the following tools:
a torque wrench,
an allen key,
a standard, Phillips, or special screwdriver, and
a toolset configured to discourage unauthorized disassembly.

22. An assembly for electrical transmission comprising:
a fastener configured for an electrical power distribution application, the fastener comprising:
an aluminum (Al) metal matrix composite (MMC) comprising nanoscale carbon particles in a concentration of 0.01 to 2 percent by weight (wt %),
wherein the nanoscale carbon particles are evenly distributed throughout an entirety of the Al-MMC; and
a conductor comprised of:
pure Al,
an Al alloy, or
an Al-C MMC.

23. The assembly of claim 22, wherein the conductor is a busbar, a wire, or a cable.

24. A process for obtaining an even distribution of nanoscale carbon particles throughout an entirety of a metal matrix composite (MMC) fastener, the process comprising:
obtaining a MMC feedstock material comprising a metal matrix and nanoscale carbon particles; and
processing the MMC feedstock material through a solid-state deformation process during or prior to MMC fastener production to thereby form an MMC fastener with an even distribution of the nanoscale carbon particles throughout an entirety of the MMC fastener.

25. The process of claim 24, wherein the solid-state deformation process comprises an extrusion process.

26. The process of claim 24, wherein the solid-state deformation process comprises an equal channel angular pressing (ECAP) process.

27. The process of claim 24, wherein the MMC feedstock material is an Al-MMC feedstock material.
